(19) United States
(12) Patent Application Publication
(10) Pub. No.: US 2013/0315404 A1
(43) Pub. Date: Nov. 28, 2013

(54) OPTIMUM BROADCAST AUDIO CAPTURING APPARATUS, METHOD AND SYSTEM

(71) Applicant: Bruce Goldfeder, Freeport, NY (US)

(72) Inventor: Bruce Goldfeder, Freeport, NY (US)

(21) Appl. No.: 13/481,668

(22) Filed: May 25, 2012

(51) Int. Cl. H04R 3/00; H04R 29/00

(52) U.S. Cl. 381/58; 381/92

(57) ABSTRACT

The OPTIMUM BROADCAST AUDIO CAPTURING APPARATUS, METHOD AND SYSTEM (“OBAC”) transforms selection request, video feeds, and, audio feeds inputs via OBAC components into synchronized and optimum video and audio outputs. In one embodiment, a processor-implemented method for capturing optimal audio in sports broadcasting is disclosed, comprising: receiving real time data from a first instrumented camera situated in a venue; processing the real time data to determine a first field position in the venue; activating a first microphone from a plurality of microphones in a first microphone array based on the first field position; and sending a first audio selection from the first microphone.

### TECHNICAL FIELD

The present innovations generally address apparatuses, methods, and systems for professional broadcasting and production, particularly sporting event broadcasting and production, and more particularly, include OPTIMUM BROADCAST AUDIO CAPTURING APPARATUS, METHOD AND SYSTEM (“OBAC”).

### BACKGROUND

Broadcasters provide video and audio content to audiences. In a broadcasting event, for example, sports broadcasting from a large outdoor venue, multiple cameras and microphones may be used to capture video and audio from different locations in the venue. One channel of the video and the audio is typically provided to television audiences at a time, while additional audio and video content is often captured for later, non-real time uses.

### BRIEF DESCRIPTION OF THE DRAWINGS

The accompanying drawings illustrate various non-limiting, exemplary, innovative aspects in accordance with the present descriptions:

FIG. 1 shows a block diagram illustrating example aspects of optimum audio capturing in some embodiments of the OBAC;

FIGS. 2A-2B show data flow diagrams illustrating various embodiments of the OBAC;

FIG. 3 shows logic flow diagrams illustrating various embodiments of the OBAC;

FIGS. 4A-4B show block diagrams illustrating example configurations of microphone arrays in some embodiments of the OBAC;

FIGS. 5A-5B show block diagrams illustrating example system configurations of the OBAC;

FIG. 6 shows a flow chart diagram illustrating example aspects of the camera selection in some embodiments of the OBAC;

FIG. 7 shows a flow chart diagram illustrating example aspects of the target object coordinates calculation in some embodiments of the OBAC;

FIG. 8 shows a flow chart diagram illustrating example aspects of the audio selection in some embodiments of the OBAC;

FIG. 9 shows a flow chart diagram illustrating example aspects of the synchronization process of the OBAC;

FIG. 10 shows a flow chart diagram illustrating example aspects of calibration process of the OBAC; and

FIG. 11 shows a block diagram illustrating embodiments of the OBAC controller.

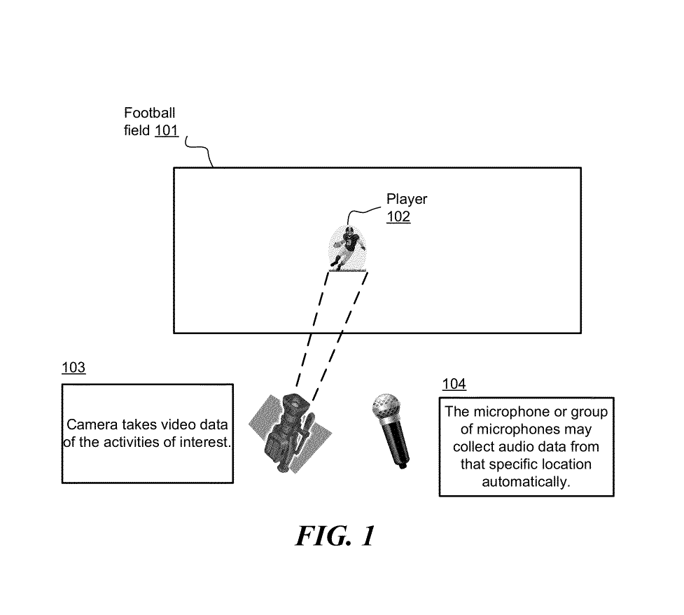

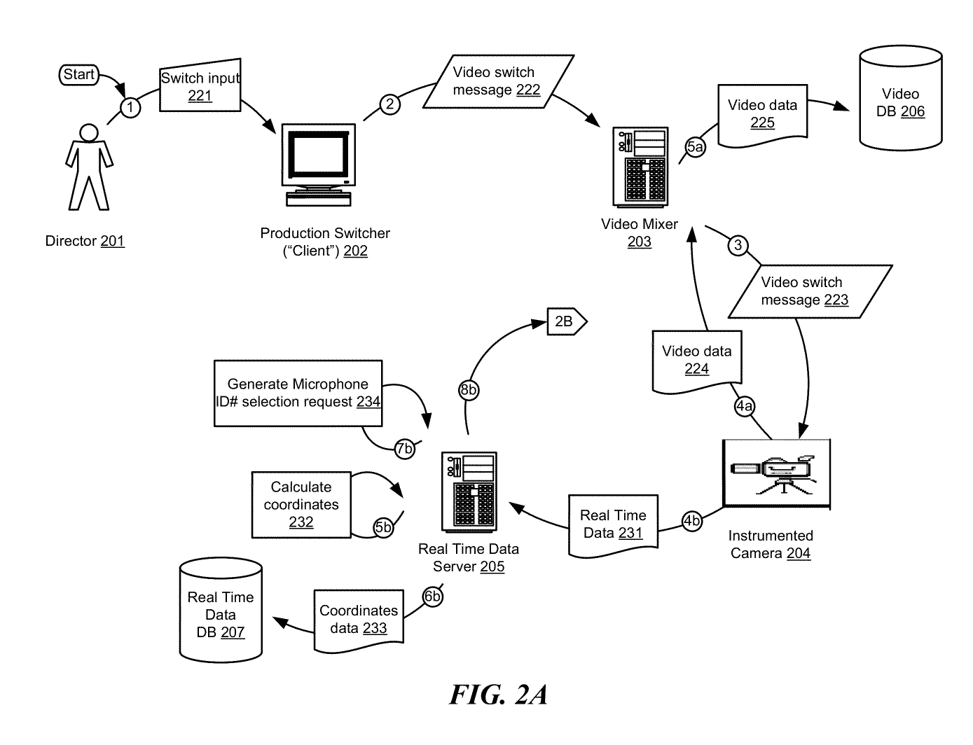

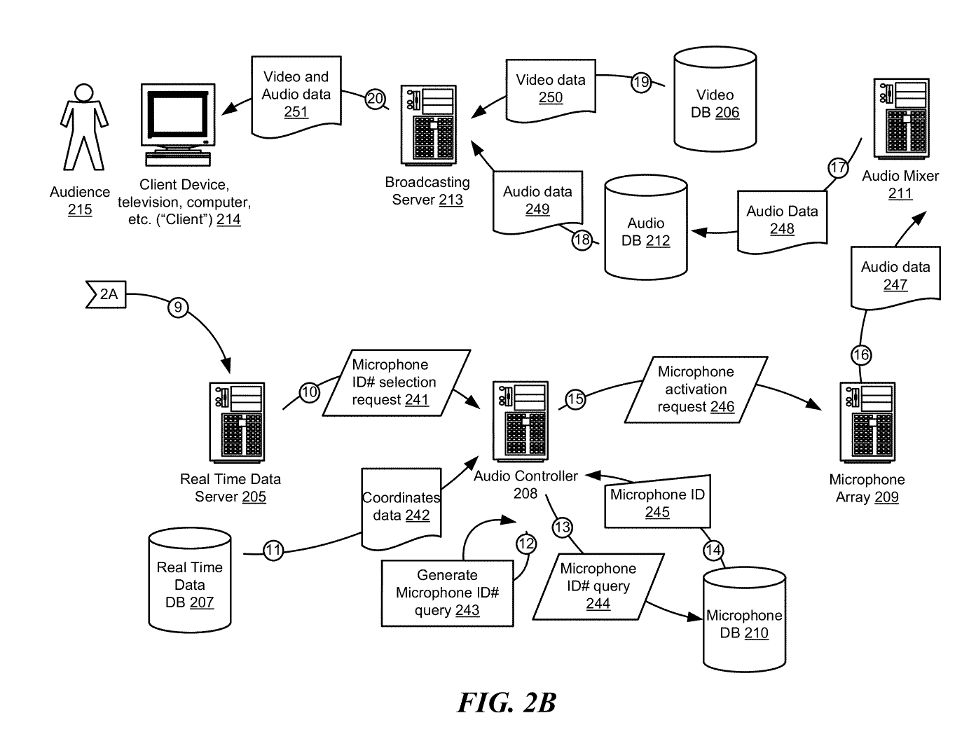

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

A. Optimum Audio Capturing

The OPTIMUM BROADCAST AUDIO CAPTURING APPARATUS, METHOD AND SYSTEM (hereinafter “OBAC”) transforms selection request, video feed, and, audio feed inputs via OBAC components into synchronized and optimized video and audio outputs for broadcast or other uses. Professional quality expectations of audiences and producers for broadcast require specialized equipment and systems which differ in many respects from consumer devices. Especially in sports broadcasting, and particularly in sports broadcasting from large outdoor venues, including for example football, soccer, many Olympic events or the like, quality, reliability, portability and related equipment and system characteristics are important. Some large indoor sports venues pose similar challenges for the broadcaster, and in any event new and improved systems are needed to support both on-air and off-air (or non-real time) uses by media companies and to provide improved viewer experiences. FIG. 1 shows a block diagram illustrating example aspects of optimum audio capturing in some embodiments of the OBAC. In some embodiments, the OBAC may facilitate optimum audio capturing from a target of interest to audiences in a broadcasting event (e.g., a sports event, a conference, a musical performance, a public gathering, etc.). For example, media companies may broadcast football games to an audience via a media device (e.g., television, set top box cell phone, network-connected computer, etc.). In the exemplary football field 101, a camera may be set up to capture video aspects of the game 103. The camera may focus on a location where a player 102 stands 102 and broadcast the activities captured from that location to audiences. The use of an 0n-camera microphone is optional and not always optimal. In one implementation, the OBAC may facilitate capturing specific sound from that specific location 104. In some embodiments, the OBAC may select to capture specific sound from any location in a venue. Preferably, the captured audio feed may be coupled together with the video feed to be transmitted to the audiences. In another implementation, the captured audio feed may be stored for broadcasting at a later time, e.g., replay or later broadcast (or other distribution) as part of a “package”.

In some embodiments, the OBAC may facilitate to capture specific audio from a large area where the source of the audio is continuingly changing. Cameras located in a venue to capture the video may be instrumented with sensors to receive Real Time Data (RTD). RTD may include zoom data of the camera lens, tilt data of the camera head (i.e., azimuth and altitude), and coordinates of the camera in three dimensions (i.e., horizontal x, horizontal y, and vertical z). The RTD may be used to generate a virtual image, for example, the first and ten lines in a football match. The RTD may give the precise position of the player or object which the camera has framed as they are moving during the game. Such position may also be the position where the audio data should be captured. Microphone arrays (MA) may be deployed in the vicinity of selected cameras that have instrumented Pan Heads that gather the RTD. As is discussed further below, a computer program may be used to control the microphones in the MA to capture the sound from the direction of the players, or a position of interest on the field or near the venue, based on the RTD. The resulting audio and video may be processed for live or delayed transmission to viewers, may be stored for later processing into “packages” such as highlights, specialized reports, bloopers, etc., or may be used for other uses (including more than one of the foregoing uses)

In some embodiments, the microphones may be directional microphones, shotgun microphones, or the like. For example, Sennheiser MKH 60 shotgun microphones, Audio-Technica ATR-55 or Shure SM89 microphones may preferably be used to capture the sound. Two directional microphones may be placed in an angle. The sound in the entire area formed by the two directional microphones may be enhanced, focused and captured using known techniques. The sound outside of area may selectively not be captured.

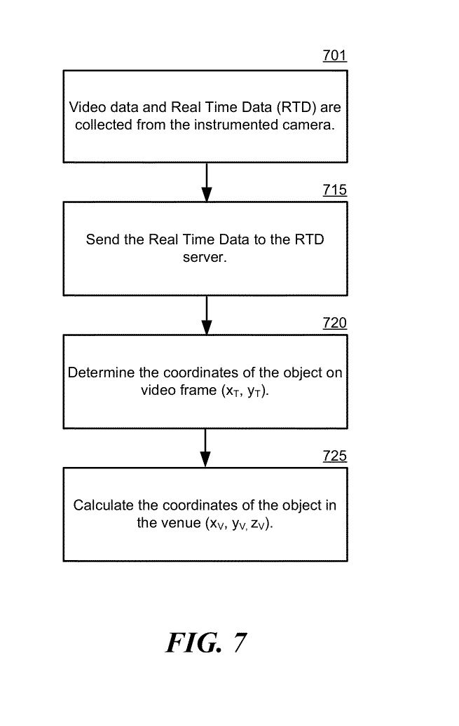

FIGS. 2A-2B show data flow diagrams illustrating various embodiments of the OBAC. With reference to FIG. 2A, when a broadcasting director 201 sees all video feeds transmitted from cameras located in a venue (e.g., a football field), the director may input to select a video feed, or switch from one video feed to another 221, through General Purpose Output (GPO) of a Production Switcher 202, to be transmitted for broadcasting to audiences. The video switch message 222 may be transmitted from the Production Switcher to the Video Mixer 203, and to 223 the selected Instrumented Camera 204. Instrumented Cameras may be cameras located in a venue to capture the video and instrumented with sensors to receive the RTD. The video data captured by the instrumented camera may be transmitted to the video mixer 224 and stored 225 in the Video Database 206. The Real Time Data (RTD) captured by the instrumented camera may be sent 231 to the Real Time Data Server 205. The Real Time Data Server may use the collected RTD to calculate the coordinates of the targeted object in the venue 232 (e.g., the player, the reference, etc.). The details of the coordinates calculation are discussed in FIG. 7. The calculated coordinate data may be stored 233 in the Real Time Data Database 207. The Real Time Data Server may generate microphone ID selection request 234. As used, a microphone ID may relate to one or more microphone elements in an array or one or more sets of microphone elements in one or more arrays. Pre-set groupings may also be created and/or stored.

With reference to FIG. 2B, the microphone ID # selection request may be sent 241 from the Real Time Data Server to Audio Controller 208. To be able to determine which microphone(s) in one or more microphone arrays should be activated to capture the sound, the coordinates of the target may be retrieved from the Real Time Data database 242 after a query to retrieve the data is sent to the database. The Audio controller may generate a microphone ID number query 243, and send the query 244 to the Microphone Database 210. The Microphone Database may retrieve one or more microphone ID number(s) associated with the coordinates and send back to the Audio Controller 245. The Audio Controller may send the microphone activation request 246 to the microphone array 209. In one embodiment, the microphone array may turn on the microphone(s) associated with the microphone ID number(s), and turn off the microphone(s) whose microphone ID number(s) are not selected. In another embodiment, all the microphones may be turned on to capture audio from different locations and only those with selected microphone ID number(s) may be transmitted for broadcasting or other uses.

Once the audio data are captured from the activated microphone(s), it may be sent 247 to the Audio Mixer 211, and stored 248 in the Audio Database 212. The audio data stored in the Audio Database 249 and the video data stored in the Video Database 250 may be sent to the Broadcasting server 213, which may further be transmitted 251 to the audiences 215, via client media device(s) (e.g., standard or smart television, cell phone, network-connected computer, etc.) 214.

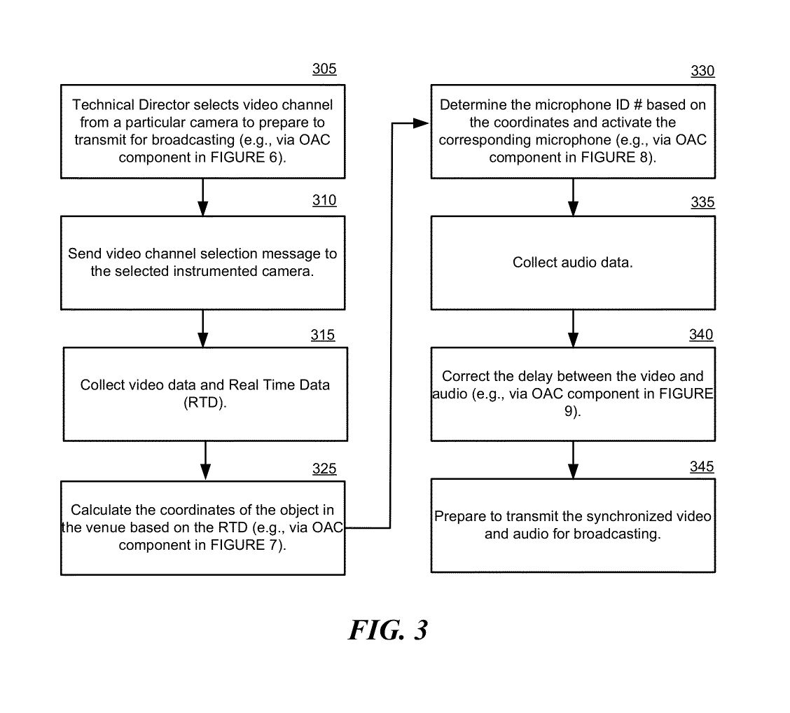

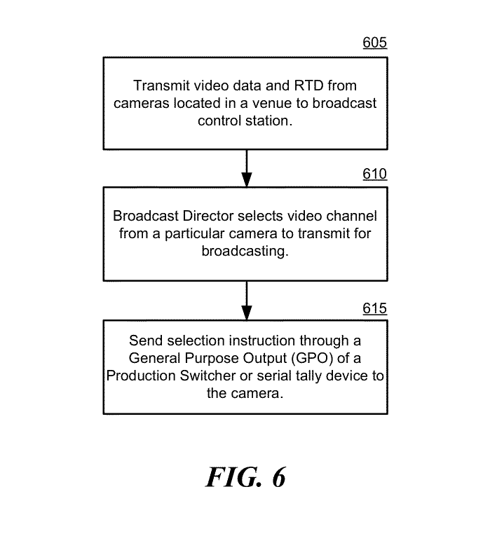

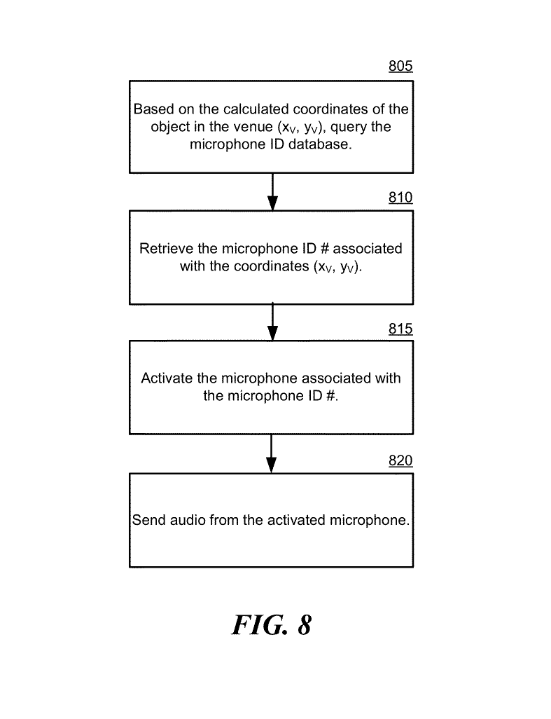

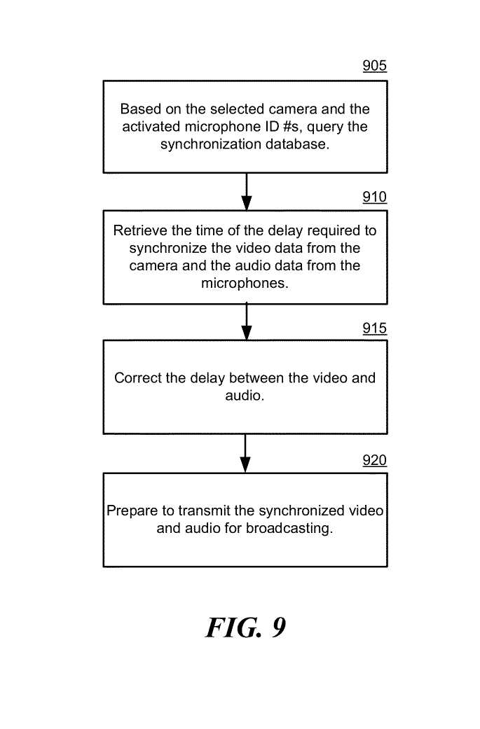

FIG. 3 shows logic flow diagrams illustrating various embodiments of the OBAC. In some embodiments, a technical director may select a video channel from a particular camera for broadcasting 305. Details about the selection algorithm are discussed in FIG. 6. The video channel selection message may be sent to the selected instrumented camera 310. In response to the selection message, video data may be captured by the camera 315. Depending on the movement of the camera, the camera head, and the camera lens (e.g., zoom, focus, etc.), Real Time Data (RTD) 315 may be collected and used to calculate the coordinates of the object of target in the venue 325. Details about the coordinate calculation are discussed in FIG. 7. Based on the coordinates of the object, microphone ID number(s) associated with microphone(s) is(are) determined and corresponding microphones are activated to capture the specific sound 330. Details about the microphone activation process are discussed in FIG. 8. Audio data from that specific location of the object of target may be collected by the activated microphone(s) 335. Based on the distance from the microphone to the object of target, delay between the video and the audio may happen 340. Methods discussing the delay correction can be found in FIG. 9. Once the video and the audio are synchronized, the data may be transmitted to broadcasting channels for viewing by audiences 345.

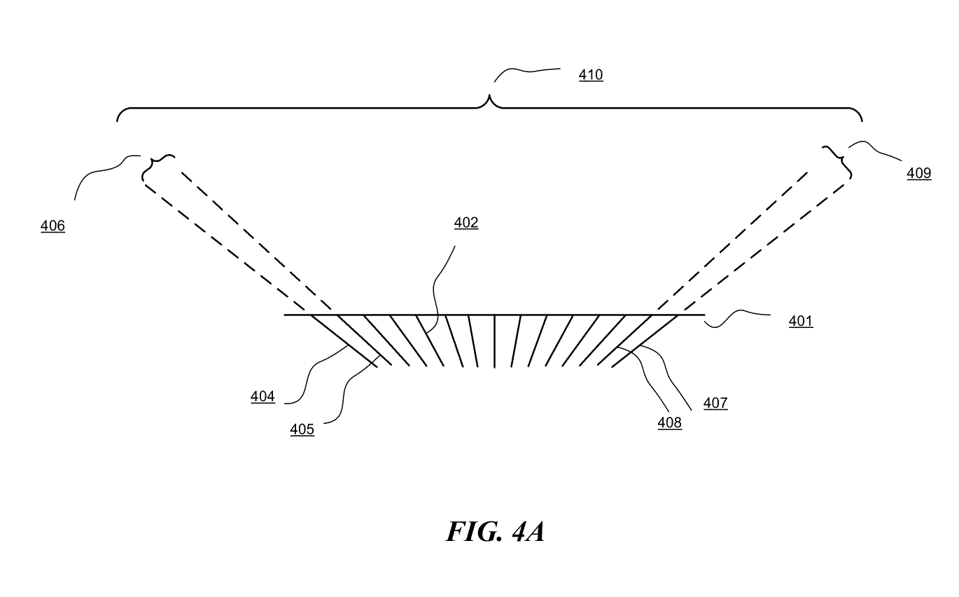

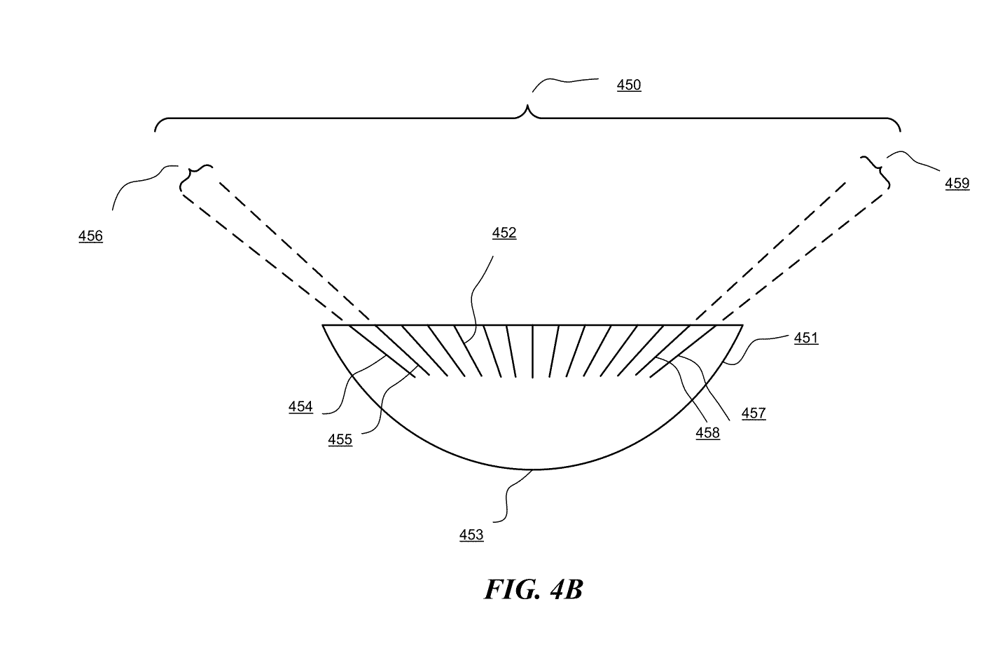

FIGS. 4A-4B show block diagrams illustrating example configurations of microphone arrays in some embodiments of the OBAC. With reference to FIG. 4A, in some embodiments, multiple microphones 402 may be placed in an array 401. The array may be suitably sized and shaped for ease of transport by broadcast team personnel and configured for ease of set up, take down, durability, weather resistance, etc. In one embodiment, the array may be substantially rectangular, about four feet long by about three feet wide and on the order of up to about six inches thick. A durable casing (including, optionally, a cover) provided with hanging brackets or attachment points may be included. In one implementation, a range of 15 to 20 sensitive directional microphones may be used in the microphone array. Microphones are placed with an angle relative to each other so that directional and selectable sound from a large area 410 may be captured. For example, microphone 404 and 405 are placed in an angle as illustrated. When activated, sound from area 406 may be captured. Microphone 407 and 408 are placed with an angle and sound from area 409 may be captured when activated. Precise placement and configuration of individual microphones is believed to be a routine design choice for a skilled broadcast engineer.

With reference to FIG. 4B, in some embodiments, a parabolic dish 451 may be equipped with multiple directional microphones 452. The front of the microphones may point inward to 453, and the back of the microphones may point outward. When directional microphones 454 and 455 are activated, the sound in area 456 may be focused and captured. Similarly, when directional microphones 457 and 208 are turned on, the sound in the area 459 may be focused and captured. The parabolic microphone array may enable accurate audio capture from a specific area. In the meantime, when all microphones are turned on, audio from a large area 450 may be covered.

In one embodiment, all the directional microphones are activated, while only audio from certain microphone inputs are selected and transmitted for broadcasting. In another embodiment, the microphone arrays may be placed on a surface of any shape, which need not be planar or parabolic. It may be understood that the array need not be strictly parabolic and that substantially parabolic (or, indeed, other curved, non-planar surfaces and shapes) configurations may be used. In yet another embodiment, other types of known arrays, including phased arrays, may be deployed.

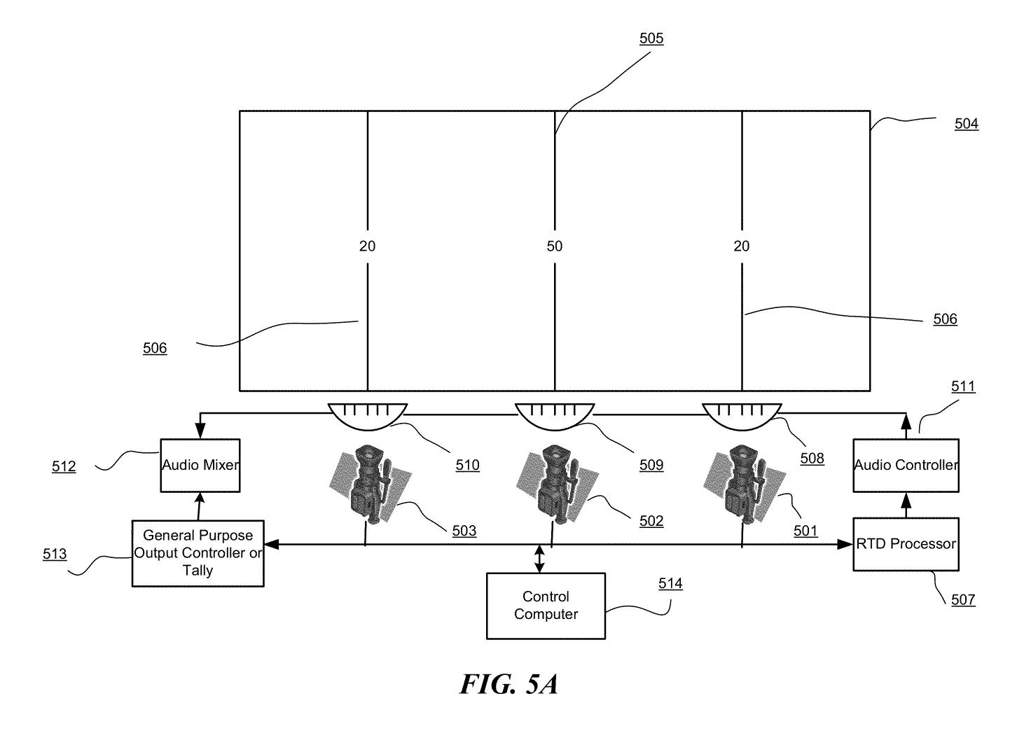

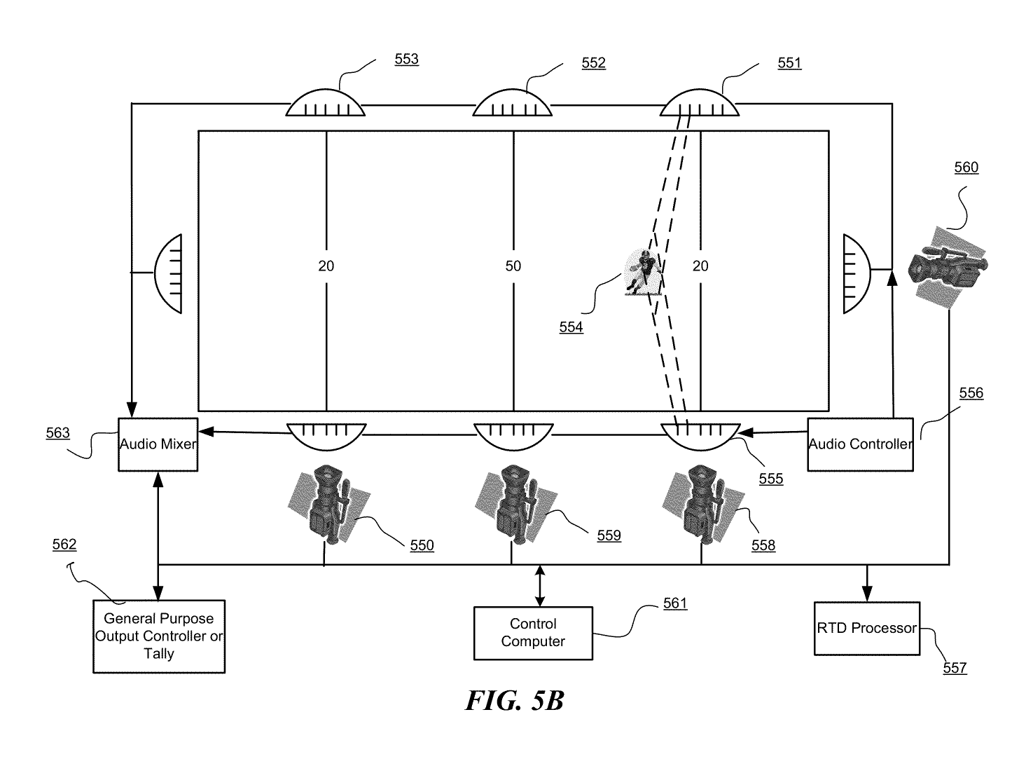

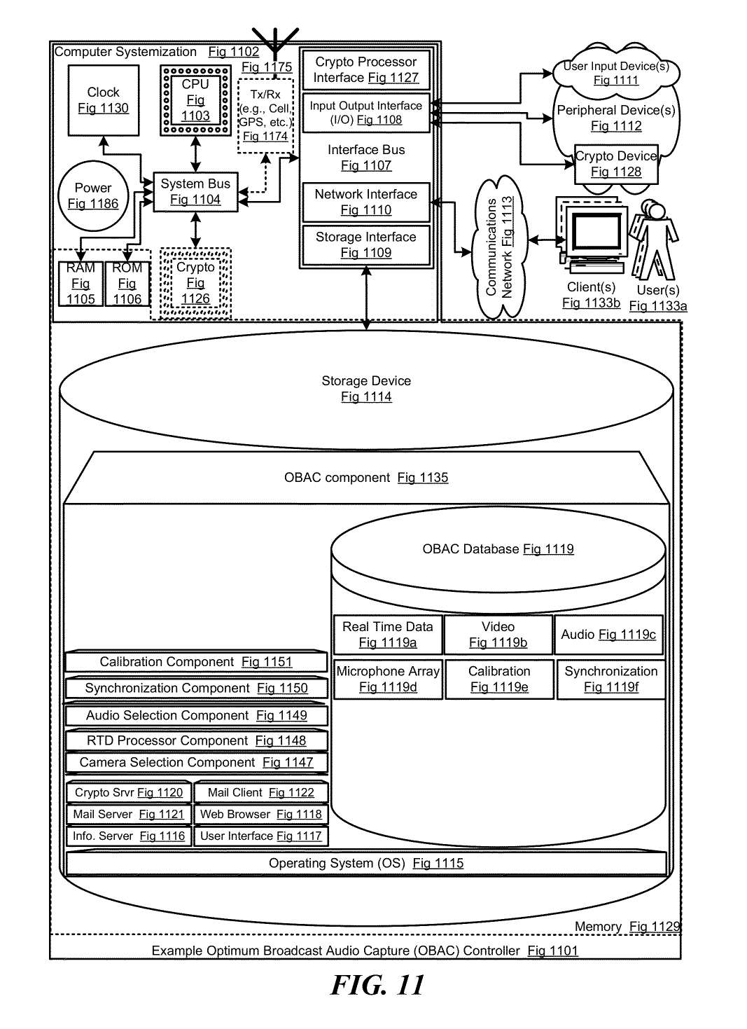

FIGS. 5A-5B show block diagrams illustrating example system configurations of the OBAC. With reference to FIG. 5A, as an example, in a football broadcast, in some embodiments, three main cameras 501, 502 and 503 may be used on the Announcer's side of a football field 504: one on the fifty-yard line 505, and one on each twenty-yard line 506. All of the cameras may be instrumented to capture Real Time Data (RTD). The RTD may be conventionally used to generate and display video overlays such as the first and ten lines that a TV viewer sees during a live broadcast of the football game. The RTD may be collected by the cameras and processed by the RTD processor 507. The RTD may include zoom data of the camera lens, tilt data of the camera head (i.e., azimuth and altitude), and coordinates of the camera in three dimensions (i.e., horizontal x, horizontal y, and vertical z). The system may communicate with, and receive control signals from, a control computer 514, which may preferably be an OBAC controller as shown in FIG. 11 or described below.

In some embodiments, three substantially parabolic microphone arrays 508, 509 and 510 may be placed in the vicinity of the cameras. In this example, the array configuration is more like a parabola than another curved surface, though that will be understood to be a design choice. An audio controller 511 may be deployed to control the on and off status of each directional microphone on the array. By incorporating the RTD, the audio controller may locate the position of the activities, and subsequently choose which microphones to turn on or off (or otherwise select or deselect). Therefore, the sound from a specific area on the field may be captured. The microphone array audio may be aggregated to a central audio mixer 512. The audio mixer may select which microphone array to output either automatically via a General Purpose Output (GPO) of a Production Switcher or an integrated serial tally system (such as a DNF Controls GTP-32 Programmable Logic Control Pr0cessor) 513 from the Television Mobile Units (TMU), or may be manually selected. This GPO may be in the form of a closure of an electrical circuit or a signal from a serial tally device, and will preferably also result in depicting which of the multiple cameras available for selection is currently selected on the TMU's production switcher. The signal from the serial tally device could, for example, be sent using the RS 422 Serial Data Protocol. Preferably this will allow the automatic selection of the sound from the specific selected microphone(s) (or arrays) for the camera which is on air.

In some embodiments, different numbers of the microphone arrays may be placed in different locations relative to the cameras. For example, instead of three microphone arrays, two arrays may be deployed, with each placed in between the twenty-yard line and fifty-yard line.

With reference to FIG. 5B, in some embodiments, three additional microphone arrays 551, 552, and 553 may be placed on the corresponding fifty-yard line, and each twenty-yard line on the other side of the football field. When a player 554 is at the same distance from each sideline, the sound from the player may travel substantially the same distance to the microphone arrays 551 and 555. As a result, the focus of the sound may be enhanced. The audio controller 556 may control these additional microphone arrays by integrating the real time data from the RTD processor 557. In another embodiment, the real time data taken from cameras 558, 559 and 550 may be offset by 180 degrees to be used in parabolic microphone arrays on the other side of the field. Additionally, an Audio Mixer 563, a GPO/tally 562 and a Control Computer 561 may be included, consisting of essentially the same components as in FIG. 5A and functioning substantially as described in connection with FIG. 5A.

In some embodiments, a camera may be placed in a high overhead position to show all of the field, and another camera, e.g 560 (as well as additional microphone arrays) may be placed near one or both end zones, as shown. Real time data may be instrumented with these cameras, which can be further used to control the focus of the selectable captured sound.

FIG. 6 shows a flow chart diagram illustrating example aspects of the camera selection in some embodiments of the OBAC, e.g., a Camera Selection component 1147 in FIG. 11. In some embodiments, the component transforms a sports broadcast director's selection of a shot into a selection of a camera, thus obtaining the video data and the Real Time Data from the correct camera. In some embodiments, video data and RTD from one or more cameras located in a venue may be transmitted to the broadcast control station 605. When the broadcast director views video from different camera angles, a specific video angle may be selected for broadcasting by the broadcast director 610. The selection instruction may be sent through a General Purpose Output of a Production Switcher, such as a Grass Valley Kalypso™ or Kayennne™ or a Sony MVS-8000, to the selected camera 615. As previously discussed, the instruction may also be a signal sent by a serial tally system.

FIG. 7 shows a flow chart diagram illustrating example aspects of the target object coordinates calculation in some embodiments of the OBAC, e.g., a RTD processor component 1148 in FIG. 11. In some embodiments, when video data are collected from the instrumented camera, Real Time Data (RTD) may be collected from the instrumented camera 701. RTD may include zoom data of the camera lens (Ω_{c}), tilt data of the camera head (i.e., azimuth φ_{c} and altitude θ_{c}), and coordinates of the camera in three dimensions (i.e., horizontal x_{c}, horizontal y_{c}, and vertical z_{c}). The RTD may be sent to the RTD server 715. The coordinates of the object on the video frame (x_{T}, y_{T}) may be determined 720. Based on the following algorithms, the coordinates of the object in the venue (xᵥ, yᵥ, zᵥ) may be calculated 725:

(y_{z}−y_{c})/(xᵥ−x_{c})=tan θ_{z}

(zᵥ−z_{c})/((xᵥ−x_{c})²+(yᵥ−y_{c})²+(zᵥ−z_{c})²)=cos φ_{z}

Where
sin(θ_{c}−θ_{z})=x_{T}*sin Ω_{c}
sin(φc−φ_{z})=y_{T}*sin Ω_{c}

FIG. 8 shows a flow chart diagram illustrating example aspects of the audio selection in some embodiments of the OBAC, e.g., a Audio Selection component 1149 in FIG. 11. In some embodiments, the OBAC may query the Microphone Array Database to retrieve the microphone ID number associated with the calculated coordinates of the object 805. Once the microphone ID number is retrieved 810, the microphone associated with the microphone ID may be activated 815. Audio from the microphone may be captured and transmitted to the audio mixer 820. For example, if the horizontal coordinate of the object xᵥ is between 10 feet and 12 feet from the 50 yard line, and the vertical coordinate of the object yᵥ is between 5 feet and 6 feet from the announcer side line, microphone No. 3 in microphone array No. 2 may be turned on to capture audio from the object. In some embodiments, all microphones may be activated to capture audio at the same time, in other embodiments, only a selected subset of all microphones in a given array will be activated. All audio feeds may be sent to an Audio Mixer. In one implementation, based on the coordinates of the object, the corresponding microphone may be selected for broadcasting. In another implementation, the audio feeds not associated with the target object may be stored and used after broadcasting (e.g., replay edited into packages, etc.).

In some embodiments, two audio feeds may be captured based on one object. If the distance from the object to each microphone is the same, the two audio feeds may be added together to provide an enhanced audio. If the distance is different, an offset may be added using known techniques to one audio feed to synchronize the two audio feeds which may then be added together to provide enhanced audio.

FIG. 9 shows a flow chart diagram illustrating example aspects of the synchronization process of the OBAC, e.g., a Synchronization component 1150 in FIG. 11. In some embodiments, based on the selected camera and the activated microphone ID number(s), the OBAC may query the synchronization database 905, to retrieve the time of the delay required to synchronize the video data from the camera and the audio data from the microphone(s) 910. The delay may be added to correct between the video and the audio 915. The synchronized video and audio may be transmitted to broadcasting channels for viewing to the audiences 920.

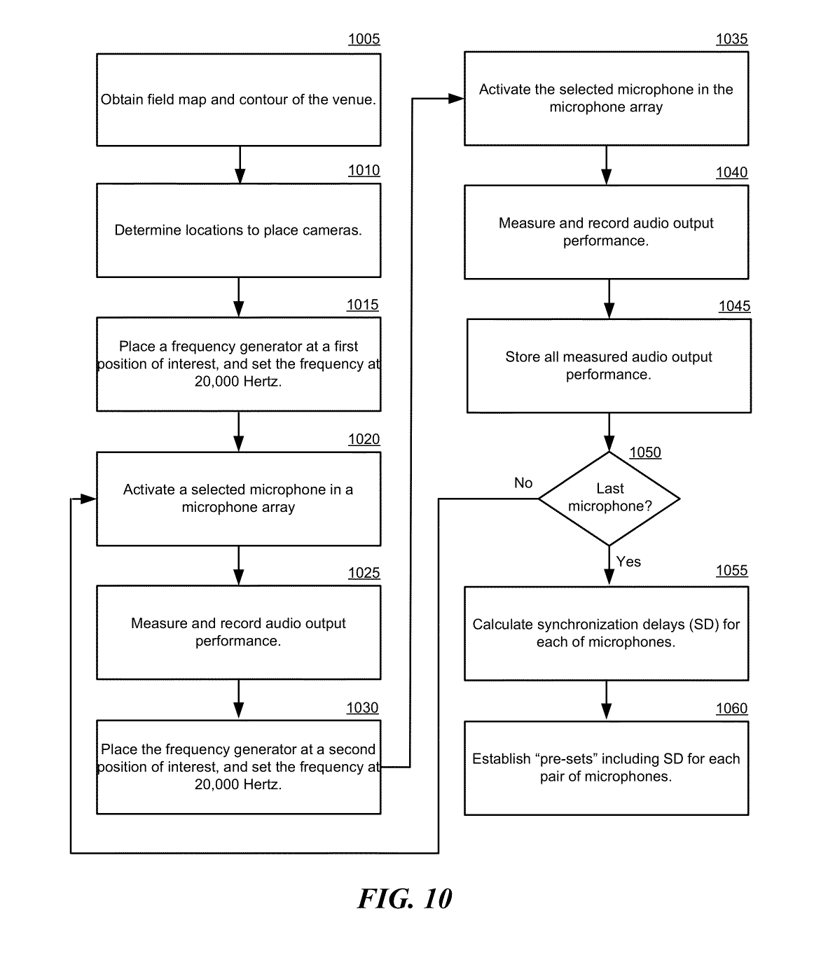

FIG. 10 shows a flow chart diagram illustrating example aspects of calibration process of the OBAC, e.g., a Calibration component 1151 in FIG. 11. In some embodiments, a calibration process may be performed before a broadcasting event to assess the performance of cameras, microphones, microphone arrays, and optimum locations to place the cameras and microphones. It will be appreciated that calibrating and optimizing a broadcast audio system for use in a large outdoor venue, such as a football stadium, particularly on the short fused schedule applicable to broadcasting professional sports events, is in many ways different from laboratory or concert hall conditions. For example, calibration may typically need to be performed while the spectators are filing into their seats rather shortly before the start of the event or while a team is practicing. Thus, for example, it is desirable to perform the calibration quickly and without bothering the spectators or athletes. A field map and contour of the venue may be obtained 1005. Cameras may be calibrated to determine the optimum locations for full view of the venue 1010. A frequency generator may be placed at a first position of interest (e.g., at the middle of the football field) with a frequency pre-set at 20,000 Hertz 1015. In some embodiments, a range of up to several discrete frequencies between 15 hertz and 35,000 hertz may be used, preferably between about 22 hertz and 30,000 hertz and not more than 5-6 frequencies. In another embodiment a first frequency sweep between about 10-18 Hz may be conducted for about 30 seconds (or until read) and be followed by a second frequency sweep between about 15,000-25,000 Hz for about the same duration. A first microphone in a first microphone array (e.g., microphone #1) may be activated 1020 to measure and record the audio output performance 1025. In some embodiments, all other microphones may be activated subsequently and individually to measure the audio output performance for sound generated from the first position of interests (e.g., at the middle of the football field). Similarly, selected portions of each array (or of selected arrays) may be tested based on venue conditions, time to set up or other factors. The microphone ID with the best performance may be stored to the Calibration Database, which may further used to update data in the Microphone Array Database, and pre-sets may similarly be created and stored.

In some embodiments, the frequency generator may be place at a second position of interest (e.g., at the center of left 20 yard line in a football field) 1030, the first microphone (e.g., microphone #1) may be activated 1035 to measure and record the audio output performance 1040. The microphone with the best performance associated with the second position of interest may be stored into the Calibration Database 1045. If the selected microphone is not the last microphone 1050, the OBAC may activate the next microphone in each array and repeat the process 1020. If the selected microphone is the last microphone, the OBAC may calculate synchronization delays (SD) for each microphone (or array) 1055 and establish pre-sets including SD for each microphone or array 1060. This process (or the variations discussed above, e.g. multiple frequencies, multiple frequency sweeps, and the like) may be repeated as needed to appropriately calibrate the OBAC system in view of time and venue constraints.

B. OBAC Controller

FIG. 11 shows a block diagram illustrating embodiments of an OBAC controller. In this embodiment, the OBAC controller 1101 may serve to aggregate, process, store, search, serve, identify, instruct, generate, match, and/or facilitate interactions witₕ a computer through broadcasting technologies, and/or other related data.

Typically, users, which may be people and/or other systems, may engage information technology systems (e.g., computers) to facilitate information processing. In turn, computers employ processors to process information; such processors 1103 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 1129 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the OBAC controller 1101 may be connected to and/or communicate with entities such as, but not limited to: one or more users from user input devices 1111; peripheral devices 1112; an optional cryptographic processor device 1128; and/or a communications network 1113.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another. In the case of sports broadcasting, professional quality audio and video may be collected in the stadium venue, processed to some extent at the Mobile Unit and forwarded via RF or optical links to a broadcast center The broadcast center may then further process the feed, add additional content and transmit over assigned frequencies to local audiences, uplink via satellite systems to remote local broadcast affiliates, uplink to cable or satellite multi-channel video providers, stream using known techniques over public or private networks etc. to deliver the content to a viewer's media consumption device for display or storage.

The OBAC controller 1101 may be based on computer systems that may comprise, but are not limited to, components such as: a computer systemization 1102 connected to memory 1129.

1. Computer Systemization

A computer systemization 1102 may comprise a clock 1130, central processing unit (“CPU(s)” and/or “processor(s)” (these terms are used interchangeable throughout the disclosure unless noted to the contrary)) 1103, a memory 1129 (e.g., a read only memory (ROM) 1106, a random access memory (RAM) 1105, etc.), and/or an interface bus 1107, and most frequently, although not necessarily, are all interconnected and/or communicating through a system bus 1104 on one or more (mother)board(s) 1102 having conductive and/or otherwise transportive circuit pathways through which instructions (e.g., binary encoded signals) may travel to effectuate communications, operations, storage, etc. The computer systemization may be connected to a power source 1186; e.g., optionally the power source may be internal. Optionally, a cryptographic processor 1126 and/or transceivers (e.g., ICs) 1174 may be connected to the system bus. In another embodiment, the cryptographic processor and/or transceivers may be connected as either internal and/or external peripheral devices 1112 via the interface bus I/O. In turn, the transceivers may be connected to antenna(s) 1175, thereby effectuating wireless transmission and reception of various communication and/or sensor protocols. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 1229 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be any appropriate microprocessor.

Depending on the particular implementation, the embedded components may include software solutions, hardware solutions, and/or some combination of both hardware/software solutions. For example, OBAC features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the OBAC features. A hierarchy of programmable interconnects allow logic blocks to be interconnected as needed by the OBAC system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the OBAC may be developed on regular FPGAs and then migrated into a fixed version that more resembles ASIC implementations. Alternate or coordinating implementations may migrate OBAC controller features to a final ASIC instead of or in addition to FPGAs. Depending on the implementation all of the aforementioned embedded components and microprocessors may be considered the “CPU” and/or “processor” for the OBAC.

2. Power Source

The power source 1186 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. The power cell 1186 is connected to at least one of the interconnected subsequent components of the OBAC thereby providing an electric current to all subsequent components. In one example, the power source 1186 is connected to the system bus component 1104. In an alternative embodiment, an outside power source 1186 is provided through a connection across the I/O 1108 interface. For example, a USB and/or IEEE 1394 connection carries both data and power across the connection and is therefore a suitable source of power.

3. Interface Adapters

Interface bus(ses) 1107 may accept, connect, and/or communicate to a number of interface adapters, conventionally although not necessarily in the form of adapter cards, such as but not limited to: input output interfaces (I/O) 1108, storage interfaces 1109, network interfaces 1110, and/or the like. Optionally, cryptographic processor interfaces 1127 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 1109 may accept, communicate, and/or connect to a number of storage devices such as, but not limited to: storage devices 1114, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 1110 may accept, communicate, and/or connect to a communications network 1113. Through a communications network 1113, the OBAC controller is accessible through remote clients 1133b (e.g., computers with web browsers) by users 1133a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed OBAC), architectures may similarly be employed to pool, load balance, and/or otherwise increase the communicative bandwidth required by the OBAC controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 1110 may be used to engage with various communications network types 1113. For example, multiple network interfaces may be employed to allow for the communication over broadcast, multicast, and/or unicast networks.

Input Output interfaces (I/O) 1108 may accept, communicate, and/or connect to user input devices 1111, peripheral devices 1112, cryptographic processor devices 1128, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 1111 often are a type of peripheral device 512 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 1112 may be connected and/or communicate to I/O and/or other facilities of the like such as network interfaces, storage interfaces, directly to the interface bus, system bus, the CPU, and/or the like. Peripheral devices may be external, internal and/or part of the OBAC controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 528), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the OBAC controller may be embodied as an embedded, dedicated, and/or monitor-less (i.e., headless) device, wherein access would be provided over a network interface connection.

4. Memory

Generally, any mechanization and/or embodiment allowing a processor to affect the storage and/or retrieval of information is regarded as memory 1129. However, memory is a fungible technology and resource, thus, any number of memory embodiments may be employed in lieu of or in concert with one another. It is to be understood that the OBAC controller and/or a computer systemization may employ various forms of memory 1129. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 1129 will include ROM 1106, RAM 1105, and a storage device 1114. A storage device 1114 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

5. Component Collection

The memory 1129 may contain a collection of program and/or database components and/or data such as, but not limited to: operating system component(s) 1115 (operating system); information server component(s) 1116 (information server); user interface component(s) 1117 (user interface); Web browser component(s) 1118 (Web browser); database(s) 1119; mail server component(s) 1121; mail client component(s) 1122; cryptographic server component(s) 1120 (cryptographic server); the OBAC component(s) 1135; and/or the like (i.e., collectively a component collection). These components may be stored and accessed from the storage devices and/or from storage devices accessible through an interface bus. Although non-conventional program components such as those in the component collection, typically, are stored in a local storage device 1114, they may also be loaded and/or stored in memory such as: peripheral devices, RAM, remote storage facilities through a communications network, ROM, various forms of memory, and/or the like.

6. Operating System

The operating system component 1115 is an executable program component facilitating the operation of the OBAC controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the OBAC controller to communicate with other entities through a communications network 1113. Various communication protocols may be used by the OBAC controller as a subcarrier transport mechanism for interaction, such as, but not limited to: multicast, TCP/IP, UDP, unicast, and/or the like.

7. Information Server

An information server component 1116 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective−) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), and/or the like.

8. User Interface

A user interface component 1117 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

9. Web Browser

A Web browser component 1118 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the OBAC enabled nodes. The combined application may be nugatory on systems employing standard Web browsers.

10. Mail Server

A mail server component 1121 is a stored program component that is executed by a CPU 1103. The mail server may be a conventional Internet mail server such as, but not limited to sendmail, Microsoft Exchange, and/or the like. The mail server may allow for the execution of program components through facilities such as ASP, ActiveX, (ANSI) (Objective−) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the OBAC.

Access to the OBAC mail may be achieved through a number of APIs offered by the individual Web server components and/or the operating system.

Also, a mail server may contain, communicate, generate, obtain, and/or provide program component, system, user, and/or data communications, requests, information, and/or responses.

11. Mail Client

A mail client component 1122 is a stored program component that is executed by a CPU 1103. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

12. Cryptographic Server

A cryptographic server component 1120 is a stored program component that is executed by a CPU 1103, cryptographic processor 1126, cryptographic processor interface 1127, cryptographic processor device 1128, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data.

13. The OBAC Database

The OBAC database component 1119 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the OBAC database may be implemented using various standard data-structures, such as an array, hash, (linked) list, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the OBAC database is implemented as a data-structure, the use of the OBAC database 1119 may be integrated into another component such as the OBAC component 1135. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 1119 includes several tables 1119a-e. A Real Time Data table 1119a may include fields such as, but not limited to: TimeStamp, Camera_ID, Camera_x, Camera_y, Camera_z, Camera_θ, Camera_φ, Camera_Ω, TV_x, TV_y, Venue_x, Venue_y, Venue_Coordinates_ID, and/or the like. The user table may support and/or track multiple entity accounts on a OBAC. A Video table 1119b may include fields such as, but not limited to: Video_Start_Time, Video_End_Time, Camera_ID, Video_Length, and/or the like. An Audio table 1219c may include fields such as, but not limited to: Audio_Start_Time, Audio_End_Time, Microphone_ID, Audio_Length, and/or the like. A Microphone Array table 1219d may include fields such as, but not limited to: Array_ID, Microphone_ID, Camera_ID, Venue_x_start, Venue_x_end, Venue_y_start, Venue_y_end, and/or the like. A Calibration table 1219e may include fields such as, but not limited to: Venue_ID, TimeStamp, Calibration_Location_ID, Calibration_Array_ID, Calibration_Microphone_ID, Calibration_Frequency, Calibration_Audio_Performance, and/or the like. A synchronization table 1219f may include fields such as, but not limited to: Camera_ID, Microphone_ID, Video_Start_Time, Video_End_Time, Audio_Start_Time, Audio_End_Time, Delay, and/or the like.

14. The OBACs

The OBAC component 1135 is a stored program component that is executed by a CPU. In one embodiment, the OBAC component incorporates any and/or all combinations of the aspects of the OBAC that was discussed in connection with the previous figures. As such, the OBAC affects accessing, obtaining and the provision of information, services, and/or the like across various communications networks.

The reader will appreciate that, as discussed above and in the figures, the OBAC transforms selection requests, video feeds, and, audio feeds inputs via OBAC components Camera Selection component 1147, Real Time Data Processor component 1148, Audio Selection Component 1149, Synchronization component 1150, and Calibration component 1151, into synchronized and optimized video and audio outputs suitable for broadcast or other uses.

The OBAC component enabling access of information between nodes may be developed by employing standard development tools and languages such as, but not limited to: Apache components, Assembly, ActiveX, binary executables, (ANSI) (Objective−) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the OBAC server employs a cryptographic server to encrypt and decrypt communications. The OBAC component may communicate to and/or with other components in a component collection, including itself, and/or facilities of the like. Most frequently, the OBAC component communicates with the OBAC database, operating systems, other program components, and/or the like. The OBAC may contain, communicate, generate, obtain, and/or provide program component, system, user, and/or data communications, requests, and/or responses.

15. Distributed OBACs

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the OBAC controller may be executing a PHP script implementing a Secure Sockets Layer (“SSL”) socket server via the information sherver, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

```
<?PHP
header(‘Content-Type: text/plain’);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of
message
do {
      $input = “”;
      $input = socket_read($client, 1024);
      $data .= $input;
} while($input != “”);
// parse data to extract variables
$obj = json_decode($data, true);
// store input data in a database
mysql_connect(“201.408.185.132”,$DBserver,$password); // access
database server
mysql_select(“CLIENT_DB.SQL”); // select database to append
mysql_query(“INSERT INTO UserTable (transmission)
VALUES ($data)”); // add data to UserTable table in a CLIENT database
mysql_close(“CLIENT_DB.SQL”); // close connection to database
?>
```

Also, the following resources may be used to provide example embodiments regarding SOAP parser implementation:

http://www.xay.com/perl/site/lib/SOAP/Parser.html
http://publib.boulder.ibm.com/infocenter/tivihelp/v2r1/index.jsp?topic=/com.ibm.IBMDI.doc/referenceguide295.htm
and other parser implementations:
http://publib.boulder.ibm.com/infocenter/tivihelp/v2r1/index.jsp?topic=/com.ibm.IBMDI.doc/referenceguide259.htm
all of which are hereby expressly incorporated by reference.

In order to address various issues and advance the art, the entirety of this application for OPTIMUM BROADCAST AUDIO CAPTURING APPARATUS, METHOD AND SYSTEM (including the Cover Page, Title, Headings, Field, Background, Summary, Brief Description of the Drawings, Detailed Description, Claims, Abstract, Figures, and otherwise) shows, by way of illustration, various embodiments in which the claimed innovations may be practiced. The advantages and features discussed are of a representative sample of embodiments only, and are not exhaustive or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, structural or topological modifications may be made without departing from the scope or spirit of the disclosure. As such, all examples or embodiments are intended to be non-limiting throughout this disclosure. Also, no inference should be drawn regarding those embodiments discussed herein relative to those not discussed herein other than it is as such for purposes of reducing space and repetition. For instance, it is to be understood that the logical or topological structure of any combination of any program components (a component collection), other components or any present feature sets as described in the figures are not limited to a fixed operating order or arrangement, but rather, any disclosed order is exemplary and all equivalents, regardless of order, are contemplated by the disclosure. Furthermore, it is to be understood that such features are not limited to serial execution, but rather, any number of threads, processes, services, servers, or the like that may execute asynchronously, concurrently, in parallel, simultaneously, synchronously, or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, or the like thereof. As such, it should be understood that advantages, embodiments, examples, functional, features, logical, operational, organizational, structural, topological, or other aspects of the disclosure are not to be considered limitations on the disclosure as defined by the claims or limitations on equivalents to the claims. It is to be understood that, depending on the particular needs or characteristics of a OBAC individual or enterprise user, database configuration or relational model, data type, data transmission or network framework, syntax structure, or the like, various embodiments of the OBAC, may be implemented that enable a great deal of flexibility and customization. For example, aspects of the OBAC may be adapted for surveillance or homeland security systems, other types of content creation and entertainment media production or the like. While various embodiments and discussions of the OBAC have been directed to sports broadcasting, however, it is to be understood that the embodiments described herein may be readily configured or customized for a wide variety of other applications and/or implementations.

I/We claim:

1. A processor-implemented method for capturing optimal audio in sports broadcasting, comprising:
receiving real time data from a first instrumented camera situated in a venue;
processing the real time data to determine a first field position in the venue;
activating a first microphone from a plurality of microphones in a first microphone array based on the first field position; and
sending a first audio clip from the first microphone.

2. The method of claim 1, wherein the real time data comprises zoom data, focus data, and panhead data associated with horizontal and vertical positions of the at least one instrumented camera;

3. The method of claim 1, wherein the first microphone is a directional microphone.

4. The method of claim 1, wherein the first microphone is a shotgun microphone.

5. The method of claim 1, further comprising:
activating a second microphone from a plurality of microphones in a second microphone array;
sending a second audio clip from the second microphone; and
selecting an audio clip from the first audio clip and the second audio clip for synchronization with corresponding video from said first camera.

6. The method of claim 6, further comprising:
activating the second microphone based on the first field position.

7. The method of claim 6, further comprising:
activating the second microphone based on a second field position.

8. A system for capturing optimal audio in sports broadcasting, comprising:
a processor; and
a memory disposed in communication with the processor and storing processor-executable instructions to:
receive real time data from a first instrumented camera situated in a venue;
process the real time data to determine a first field position of interest in the venue;
select a first microphone from a plurality of microphones in a first microphone array based on the first field position of interest; and
transmit a first audio selection from the first microphone.

9. The system of claim 8, wherein the first microphone array is shaped to provide a substantially parabolic surface.

10. The system of claim 8, wherein the first microphone array is shaped to provide a substantially flat planar surface.

11. The system of claim 8, wherein the first microphone array is positioned in the vicinity of the first instrumented camera.

12. The system of claim 8, wherein the first microphone array is removably attached to a camera platform in the venue that is at least 6 feet long and 4 feet wide.

13. A processor-implemented method for storing optimal audio collected during a sporting event in a venue, comprising:
receiving and processing real time data from a first instrumented camera situated in the venue to determine a first position of interest in the venue;
activating a first microphone from a plurality of microphones in a first microphone array based on the first position of interest;
transmitting a first audio sample from the first microphone to a television controller unit;
receiving and processing real time data from a second instrumented camera situated in the venue to determine a second position of interest in the venue;
activating a second microphone from a plurality of microphones in a second microphone array based on the second position of interest;
transmitting a second audio sample from the second microphone to the television controller unit; and
storing the first and second audio samples for later editing.

14. The method of claim 13, wherein the stored first audio is transmitted as part of an event feed to a broadcast center during the event.

15. The method of claim 13, wherein the stored first audio and second audio is prepared for broadcasting to viewers as part of an event package after the end of the event.

16. A processor-implemented method for calibrating a sound environment of a venue, comprising:
determining a first field position;
activating a first microphone from a plurality of microphones in a first microphone array based on the first field position;
measuring first audio output performance from the first microphone associated with a first frequency transmitted from the first field position.

17. The method of claim 16, further comprising:
calculating and storing a first delay period based on the location of the first microphone, the first field position, and the first frequency.

18. The method of claim 16, wherein the first frequency is about 20,000 hertz.

19. The method of claim 16, further comprising:
measuring second audio output performance from the first microphone associated with a second frequency transmitted from the first field position.

20. The method of claim 19, where the second frequency is between about 150 hertz and about 18,000 hertz.
